(19) United States
(12) Patent Application Publication
(10) Pub. No.: US 2010/0083645 A1
(43) Pub. Date: Apr. 8, 2010

(54) METHOD FOR OBTAINING A POROUS STRUCTURE BASED ON SILICON CARBIDE

(75) Inventors: Patricia Andy, Les Taillades (FR); Caroline Tardivat, Aix-En-Provence (FR); Damien Mey, Cavaillon (FR); Ahmed Marouf, Cavaillon (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: SAINT-GOBAIN CTR DE RCH ET D'ETUDES EUROPEEN, Courbevoie (FR)

(21) Appl. No.: 12/517,361

(22) PCT Filed: Dec. 13, 2007
(86) PCT No.: PCT/FR07/52506

§ 371 Date: Jun. 3, 2009

(30) Foreign Application Priority Data
Dec. 21, 2006 (FR) 0655836

(51) Int. Cl. F01N 3/035; C04B 35/565; B01J 21/06; B01J 20/02; H05B 6/64; C04B 35/64; F01N 3/28

(52) U.S. Cl. 60/311; 501/88; 502/439; 502/407; 264/432; 264/651; 60/282

(57) ABSTRACT

The invention relates to a process for obtaining a structure made from a porous ceramic material comprising at least 95% of silicon carbide SiC, said process being characterized in that said structure is obtained from a mixture of SiC grains comprising at least:
a first fraction of α-SiC grains whose median diameter is less than 5 microns;
a second fraction of α-SiC grains whose median diameter is at least two times greater than that of the first fraction of α-SiC grains and whose median diameter is greater than or equal to 5 microns; and
a fraction of β-SiC grains or of at least a precursor of β-SiC grains.

The invention also relates to the porous structure obtained according to the process.

The invention relates to the field of gas-treatment structures based on SiC and incorporating a catalytic compound, such as those used in an exhaust line of an internal combustion engine. Typically, the invention relates to supports for the treatment of polluting gases such as HCs, CO or NOₓ by a catalyzed route, or preferably to catalytic filters enabling the combined removal of polluting gases and soot produced by the combustion of a fuel in a diesel or petrol engine.

Although the invention is not limited thereto, the case of particulate filters of an exhaust line of an internal combustion engine is more particularly described in the remainder of the description. Such catalytic filters allow the treatment of the gases and the removal of the soot derived from a diesel engine and are well known in the prior art. These structures all usually have a honeycomb structure, one of the faces of this structure allowing the intake of the exhaust gases to be treated and the other face the discharge of the treated exhaust gases. The structure comprises, between the intake and discharge faces, a set of adjacent ducts or channels with axes parallel to one another separated by porous walls. The ducts are stopped at one or other of their ends to delimit inlet chambers opening onto the intake face and outlet chambers opening onto the discharge face. The channels are alternately stopped in an order such that the exhaust gases, as they pass through the honeycomb body, are forced to pass through the side walls of the inlet channels in order to join the outlet channels. In this way, the particles or soot are deposited and accumulate on the porous walls of the filtering body.

In a known manner, during its use, the particulate filter is subjected to a succession of filtration phases (accumulation of soot) and regeneration phases (removal of soot). During the filtration phases, the soot particles emitted by the engine are retained and are deposited inside the filter. During the regeneration phases, the soot particles are burnt inside the filter, in order to restore its filtration properties thereto. The porous structure is then subjected to intense mechanical and thermomechanical stresses, which may cause microcracks that are capable over time to cause a severe loss of the filtration capability of the unit, or even its deactivation or its complete deterioration. This phenomenon is particularly observed on large-diameter monolithic filters, but also to a lesser degree on the assembled filters, that is to say those incorporating a plurality of monolithic filtering elements joined together by a cement.

Usually, the filters are made of a porous ceramic material, for example silicon carbide SiC.

Examples of such catalytic filters and their manufacturing processes are, for example, described in Patent Applications EP 816 065, EP 1 142 619, EP 1 455 923 or else WO 2004/090294 and WO 2004/065088, in which a person skilled in the art will find, if necessary, the practical details of the implementation and fabrication of the SiC-based structures according to the invention.

In addition to the problem of treating soot, the conversion of gas-phase polluting emissions (that is to say mainly nitrogen oxides (NOₓ) and carbon monoxide (CO), or even unburnt hydrocarbons) to less harmful gases (such as gaseous nitrogen (N₂) or carbon dioxide (CO₂)) requires an additional catalytic treatment.

In order to treat the gaseous and solid pollutants during one and the same step, it is desired to add a catalytic function to the particulate filter previously described. According to the processes conventionally used, the honeycomb structure is impregnated by a solution comprising the catalyst or a precursor of the catalyst.

Such processes generally comprise at least one step of impregnation by immersion either in a solution containing a catalyst precursor or the catalyst dissolved in water (or an other polar solvent), or a suspension in water of catalytic particles. An example of such a process is described by U.S. Pat. No. 5,866,210.

In a known manner, the impregnation process may be carried out in one or more steps. The impregnation step or steps aims to deposit the catalyst in the structure as uniformly as possible.

Usually the catalyst comprises an active principle that includes precious metals (Pt, Pd, Rh) and optionally a rare-earth oxide, for example a mixture of platinum and cerium oxide Pt/CeO₂. The active principle is normally deposited, according to techniques well known in heterogeneous catalysis, in the porosity of an oxide support having a high specific surface area, for example alumina, titanium oxide, silica, cerine or zirconium oxide.

It is furthermore known that the introduction of a particulate filter such as described previously into the exhaust line of the engine leads to a loss of pressure, often called a pressure drop in the field, capable of impairing the performance of the engine. The porosity of the filter is consequently chosen to be high enough to avoid such an impairment and is generally between 20 and 75%.

The pressure drop is, however, even greater when the filter comprises a catalytic function. This is because the deposit of the catalytic coating, in particular of the catalyst support such as described previously, onto the walls and/or in the porosity of the structure tends to further increase the pressure drop due to the presence of the filter in the exhaust line. Due to this limitation, the amounts of catalyst deposited and consequently the efficiency of the catalytic treatment of the exhaust gases are currently limited.

It results from the aforementioned that there is a need to obtain a filtering structure having good mechanical and thermomechanical strength, of which the microstructure (porosity, specific surface area of the pores) can enable an increased amount of catalyst to be deposited so as to increase the efficiency of the treatment of the gases, but without however resulting in a large increase in the pressure drop caused by the introduction of the filter into a gas discharge duct such as an exhaust line.

A first solution that has already been described consists in increasing the porosity of the network of silicon carbide grains, by the presence in the initial mixture of a set amount of a pore-forming agent, of the synthetic resin type such as acrylic resin or of the organic polymer type such as starch, such as described in Application EP 1 403 231. However, the increase in the porosity leads, at the same time, to a severe decrease in the mechanical properties of the filter, which reduces the operating performance thereof, in particular in an application such as the particulate filter.

It is also known, for example from Application EP 1 142 619, that it is possible to obtain SiC structures having a high porosity by using, for the composition of the initial powder mixture, two fractions of α-SiC grains whose grain sizes are different, that is to say typically of the order of 10 microns for the large fraction and 1 micron for the fine fraction. Via a conventional process for shaping the structure, especially comprising the main steps of mixing with a suitable amount of water, extrusion, drying then firing, it is possible to thus obtain an open porosity of around 40% and an acceptable pressure drop for an application in an automobile exhaust line. The total developed specific surface area of the pores, measured in such structures, is however too low to enable the deposition of a sufficient amount of catalyst and a sufficient efficacy for treating the polluting gases HCs, CO and NOₓ, without greatly increasing the pressure drop caused by the catalyzed filter in the exhaust line.

Patent Application EP 1 541 817 alternatively proposes mixing a large fraction of α-SiC whose average particle size is between 10 and 50 microns and a fine fraction of β-SiC whose average particle size is between 0.1 and 1 micron. In the same way as before, the specific surface area of the pores in such structures is too low to allow the deposition of a sufficient amount of catalyst and a sufficient efficacy for treating the polluting gases HCs, CO and NOₓ, without greatly increasing the pressure drop caused by the catalyzed filter.

The object of the present invention is thus to provide a process for obtaining a porous structure of which the SiC content is greater than 95%, of which the open porosity is greater than 40% and that makes it possible to respond to the problems explained previously, said structure having, more particularly:
a specific surface area of the pores that allows the deposition of an increased amount of catalyst and an improved efficacy of the catalytic treatment of gaseous pollutants of the CO, HC and NO_{R} type;
a low pressure drop, especially so as to limit the overconsumption consumption of fuel linked to the presence of such a structure, used as a filtration system in an automobile exhaust line; and
sufficient mechanical strength to withstand intense mechanical or thermomechanical stresses, linked to the envisioned applications, especially a use in an automobile exhaust line.

In a general form, the present invention relates to a process for obtaining a structure made from a porous ceramic material comprising at least 95% of silicon carbide SiC, said process being characterized in that said structure is obtained from a mixture of SiC grains comprising at least:
a first fraction of α-SiC grains whose median diameter is less than 5 microns;
a second fraction of α-SiC grains whose median diameter is at least two times greater than that of the first fraction of α-SiC grains and whose median diameter is greater than or equal to 5 microns, preferably greater than or equal to 10 microns; and
a fraction of β-SiC grains or of at least a precursor of β-SiC grains.

In the meaning of the present description, the median diameter d₅₀ of grains or particles constituting a fraction denotes the diameter of the particles below which 50% by weight of the population of the grains is found.

For example, the median diameter of the grains of the first fraction of α-SiC grains is less than around 1 micron, preferably less than 0.8 microns.

The median diameter of the grains of the second fraction of α-SiC grains is, for example, between around 5 and around 100 microns, preferably between around 10 and around 20 microns.

According to the invention, the fraction of β-SiC grains may have a median diameter at least equal to that of the first fraction of α-SiC grains and preferably is between around 3 and around 30 microns.

The first fraction of α-SiC grains represents, for example, between 15 and 50 wt % of the mixture of SiC grains, preferably between 20 and 40 wt % of the mixture of SiC grains.

The second fraction of α-SiC grains may represent between 30 and 80 wt % of the mixture of SiC grains, preferably between 30 and 60 wt % of the mixture of SiC grains.

According to one possible mode of the invention, the fraction of β-SiC grains represents between 5 and 40 wt % of the mixture of SiC grains, preferably between 10 and 35 wt % of the mixture of SiC grains.

According to an alternative mode, the precursor of β-SiC grains is chosen from the group composed of a silicon powder in combination with amorphous carbon or graphite carbon, by a silicon alkoxide in combination with amorphous carbon or graphite carbon, or a silicon-based organometallic compound.

For example, a process for obtaining a structure made from a porous ceramic material comprising at least 95% of silicon carbide SiC according to the invention comprises the following steps:
mixing various fractions of SiC grains, so as to obtain a mixture such as described previously;
shaping the filtering structure, for example by extrusion, after compounding the mixture in a liquid such as water;
drying, for example by heating or under microwave action; and
firing the shaped porous structure in a nonoxidizing atmosphere at a temperature between around 1450° C. and around 2300° C.

Possible, but not restrictive, embodiments of the process according to the invention are given below:

The initial powder mixture, before the shaping step, may comprise temporary binding agents and plasticizers chosen, for example, from the range of polysaccharides and cellulose derivatives, PVAs, PEGs, or even lignone derivatives or chemical setting agents such as phosphoric acid or sodium silicate as long as the latter are compatible with the firing process.

Without this however being necessary for proper implementation of the structures according to the present invention, it is possible to add to the mixture pore-forming agents of the type of those conventionally used or described in the literature, in particular those described in Application EP 1 403 231.

The step of shaping the material is preferably carried out according to the invention by extrusion, but other processes are not excluded, for example any known pressing, vibration or molding process.

An intermediate step of removing the binders (or debinding) may preferably be carried out in air and preferably at a temperature below 700° C. so as to ensure sufficient mechanical strength before the actual firing or sintering step and to prevent oxidation of the SiC or of the SiC precursors.

The firing is, according to the invention, carried out at a temperature above 1450° C., preferably above 1600° C., more preferably still above 1900° C., or even above 2100° C. but generally always below 2400° C. to prevent the decomposition of the SiC. The firing is carried out under a nonoxidizing atmosphere, preferably of argon Ar, so as to obtain, at the end, a material having a high mechanical strength.

The invention also relates to a porous structure capable of being obtained by a process as claimed in one of the preceding claims.

For example, said structure comprises a central part incorporating a honeycomb filtering element or a plurality of honeycomb filtering elements joined together by a joint cement, said element or elements comprising a set of adjacent ducts or channels with axes parallel to one another separated by porous walls, said ducts being stopped by plugs at one or other of their ends to delimit inlet chambers opening onto a gas intake face and outlet chambers opening onto a gas discharge face, in such a way that the gas passes through the porous walls.

The invention moreover relates to a catalytic filter or support obtained from the preceding structure and by deposition, preferably by impregnation, of at least one active catalytic phase typically comprising at least one precious metal such as Pt and/or Rh and/or Pd and optionally an oxide such as CeO₂, ZrO₂, CeO₂/ZrO₂. Such a catalytic support may be used in an exhaust line of a diesel or petrol engine. Similarly, the preceding catalytic filter may be used as a particulate filter in an exhaust line of a diesel or petrol engine.

The invention and its advantages will be better understood on reading the nonlimiting examples which follow. In the examples, all the percentages are given by weight.

### EXAMPLES

In a compounder, various α-SiC, β-SiC or β-SiC precursor powders were mixed in the weight proportions given in table 2.

For example, in example 1 according to the prior art, 70 wt % of an α-SiC powder, whose grains had a median diameter d₅₀ of 10 microns, was firstly mixed with a second α-SiC powder, whose grains had a median diameter d₅₀ of 0.5 micron, in a first mode comparable to the powder mixture described in EP 1 142 619. Added to this mixture was a pore-forming agent of polyethylene type in a proportion equal to 5 wt % of the total weight of the SiC grains and a shaping additive of the methylcellulose type in a proportion equal to 10 wt % of the total weight of the SiC grains, as listed in table 2.

Next, the necessary amount of water was added and the mixture was compounded until a homogeneous paste was obtained whose plasticity enabled the extrusion, through a die, of a honeycomb structure. In example 1, the water requirement is, for example, 22 wt % of water, relative to the total weight of the dry SiC grains introduced into the mixture.

The dimensional characteristics of the structures obtained after extrusion, for all the examples, are given in table 1:

TABLE 1

| | |
|---|---|
| Geometry of the channels | Square |
| and of the monolith | |
| Channel density | 180 cpsi |
| | (channels per square inch, |
| | 1 inch = 2.54 cm) i.e. |
| | 27.9 channels/cm² |
| Inner wall thickness | 350 μm |
| Average outer wall | 600 μm |
| thickness | |
| Length | 15.2 cm |
| Width | 3.6 cm |

Next, the green monoliths obtained were dried by microwave action for a sufficient time to bring the content of chemically unbound water to less than 1% by weight.

The channels of each face of the monolith were alternately plugged according to well-known techniques, for example described in Application WO 2004/065088.

The monolith was then fired in air according to a temperature rise of 20° C./hour until a maximum temperature of 2200° C. was reached, which was held for 6 hours.

The characteristics and properties of the filtering materials and structures obtained according to the preceding method were evaluated according to the following techniques:

### Measurement of the Porosity and of the Specific Surface Area:

Porosity analyses using a porosimeter were carried out with a Micromeritics 9500° high-pressure mercury porosimeter.

The developed specific surface area of the pores of the various porous materials was determined by a conventional surface analysis according to the BET method. This method for measuring the specific surface area by adsorption of an inert gas was developed by S. Brunauer, P. H. Emmet and J. Teller and is well known to a person skilled in the art.

### Measurement of the Mechanical Strength:

The rupture strength was measured at ambient temperature for each example on ten monolithic units corresponding to elements from one and the same manufacturing batch with a length equal to 15.2 cm and width equal to 3.6 cm. The three-point bending assembly was achieved with a distance of 140 mm between the two lower bearing surfaces according to the ISO 5014 standard. The descent rate of the pin was constant at around 10 mm/min.

The flexural modulus of rupture MOR was calculated according to the following equation:

$$MOR = \frac{F \cdot {l}_{e} \cdot H}{8 I}$$

where F (in newtons) corresponds to the rupture strength, lₑ (in mm) corresponds to the length of the support span, H (in mm) to the height of the cross section and I (in mm⁴) to the moment of inertia. The moment of inertia is calculated according to the knowledge of a person skilled in the art as a function of the thickness of the inner and outer wall and the density of the channels.

### Measurement of the Pressure Drop:

The expression “pressure drop” is understood within the meaning of the present invention to refer to the differential pressure existing between the upstream and downstream of the filter. The pressure drop was measured according to techniques of the art, for an air flow rate of 300 m³/h in a stream of ambient air. The measurement was carried out on a filter assembled from elements such as described in table 1. These elements, resulting from one and the same initial mixture, were assembled together according to the principles described in WO 2004/065088 by bonding using a cement having the following chemical composition: 72 wt % of SiC, 15 wt % of Al₂O₃, 11 wt % of SiO₂, the remainder being made up of impurities, mostly of Fe₂O₃ and alkali or alkaline-earth metal oxides. The average thickness of the joint between two neighboring blocks was around 2 mm. The assembly was then machined, in order to form assembled filters having a cylindrical shape with a diameter of 5.66 inches, i.e. around 14.4 cm.

As a function of the various vectors for introduction of SiC into the initial mixture, the characteristics and properties of the materials evaluated according to the techniques described previously are reported in table 2 which follows:

TABLE 2

| | Example | | | | | | | | |
|---|---|---|---|---|---|---|---|---|---|
| | 1 | 2 | 3 | 4 | 5 | 6 | 7 | 8 | 9 |
| α-SiC powder | 30 | 33 | 33 | 33 | 29 | 70 | | | 30 |
| d₅₀ = 0.5 μm (wt %) | | | | | | | | | |
| α-SiC powder d₅₀ = 10 μm | 70 | 33 | 52 | 52 | 58 | | 85 | 60 | |
| (wt %) | | | | | | | | | |
| β-SiC powder d₅₀ = 12 μm | | 34 | | | | 30 | | | 70 |
| (wt %) | | | | | | | | | |
| β-SiC powder d₅₀ = 0.5 μm | | | | | | | | 40 | |
| (wt %) | | | | | | | | | |
| Si powder d₅₀ = 15 μm (wt %) | | | 10 | 11 | | | 10 | | |
| Si precursor: | | | | | 12.2 | | | | |
| tetraethylorthosilicate | | | | | | | | | |
| (wt %) | | | | | | | | | |
| amorphous C powder d₅₀ = 8 μm | | | 5 | 4 | 0.8 | | 5 | | |
| (wt %) | | | | | | | | | |
| polyethylene-type pore- | +5%* | +5%* | +5%* | +5%* | +5%* | +5%* | +5%* | +5%* | +5%* |
| forming agent d₅₀ = 25 μm | | | | | | | | | |
| methylcellulose-type | +10%* | +10%* | +10%* | +10%* | +10%* | +10%* | +10%* | +10%* | +10%* |
| shaping additive | | | | | | | | | |
| water requirement | +22%* | +22%* | +25%* | +25%* | +19%* | +22%* | +25%* | +20%* | +20%* |
| OP % (OP = porosity) | 46 | 50.3 | 53.6 | 51.8 | 46.3 | 45 | 54.7 | 45 | 48 |
| MOR (MPa) | 15 | 20 | 17.5 | 22 | 22 | 13 | 8.5 | 17 | 3 |
| specific surface area m²/g | 0.05 | 0.5 | 0.4 | 0.4 | 0.3 | 0.7 | 0.4 | 0.1 | 0.5 |
| (BET) | | | | | | | | | |
| pressure drop (millibar) | 15 | 16 | 13 | 14 | 18 | 25 | 11 | not | not |
| | | | | | | | | measured | measured |
| MOR × BET surface | 0.8 | 10.0 | 7.0 | 8.8 | 6.6 | 9.1 | 3.4 | 1.7 | 1.5 |
| (MPa · m²/g) | | | | | | | | | |

*% addition relative to the total weight of SiC introduced into the initial mixture

In the results reproduced in table 2, the product MOR×specific surface area has also been reported, which makes it possible to simply and directly express the efficiency of the compromise between the expected catalytic properties of the porous material forming the filter compared to its mechanical strength properties.

Examples 2 to 5 are exemplary embodiments according to the invention.

Example 1 and 6 to 9 illustrate comparative examples given purely by way of illustration to emphasize the advantages of the present invention.

More particularly:

The comparison of the results from examples 2 to 4 according to the invention with example 1 according to the prior art shows a significant increase in the specific surface area and an improvement or retention of the mechanical properties of the material, despite the large increase in the open porosity OP volume.

Finally, the substantial improvement of the MOR×specific surface area product expresses a better compromise between the anticipated catalytic and mechanical properties of the filter according to the invention.

Comparative examples 6 to 9 illustrate modes in which one of the SiC fractions according to the invention is missing in the initial mixture.

The results obtained according to examples 6 and 7 (see table 2) show that the absence of one of the two α-SiC fractions does not allow a material with sufficient mechanical strength to be obtained. In addition, the MOR×specific surface area product is too low in the case of the material obtained according to example 7 and the pressure drop is too high in the case of the material obtained according to example 6.

The material from example 8, obtained according to the experimental method described in example 1 of Application EP 1 541 817, is derived from a formulation of the initial mixture of SiC fractions in which the fine fraction of α-SiC grains is absent and in which the median diameter of the β-SiC powder is 0.5 microns (fines). The results indicate a mechanical strength MOR and a specific surface area substantially below the values obtained according to examples 2 to 5 according to the invention.

Example 9 shows that an added level of large β-SiC particles that is too high greatly penalizes the mechanical strength and results in a MOR×surface area compromise that is much too low.

In the preceding description and examples, for reasons of simplicity the invention was described in relation to catalyzed particulate filters allowing the removal of gaseous pollutants and soot present in the exhaust gases exiting an exhaust line of a diesel engine.

The present invention also relates, however, to other structures for treating polluted gases, for example to catalytic supports for removing gaseous pollutants typically placed at the outlet of petrol or even diesel engines. In this type of structure, the honeycomb channels are not obstructed at one or other of their ends. Applied to these supports, the implementation of the present invention has the advantage of increasing the specific surface area of the support and consequently the amount of active phase present in the support, without however affecting the overall mechanical strength of the support.

1. A process for obtaining a structure made from a porous ceramic material comprising at least 95% of silicon carbide, SiC, wherein said structure is obtained from a mixture of SiC grains comprising at least:
a first fraction of α-SiC grains whose median diameter is less than 5 microns;
a second fraction of α-SiC grains whose median diameter is at least two times greater than that of the first fraction of α-SiC grains and whose median diameter is greater than or equal to 5 microns; and
a fraction of β-SiC grains or of at least a precursor of β-SiC grains.

2. The process as claimed in claim 1, in which the median diameter of the grains of the first fraction of α-SiC grains is less than around 1 micron.

3. The process as claimed in claim 1, in which the median diameter of the grains of the second fraction of α-SiC grains is between around 10 and around 100 microns.

4. The process as claimed in claim 1, in which the fraction of β-SiC grains has a median diameter at least equal to that of the first fraction of α-SiC grains and is between around 3 and around 30 microns.

5. The process as claimed in claim 1, in which the first fraction of α-SiC grains represents between 15 and 50 wt % of the mixture of SiC grains.

6. The process as claimed in claim 1, in which the second fraction of α-SiC grains represents between 30 and 80 wt % of the mixture of SiC grains.

7. The process as claimed in claim 1, in which the fraction of β-SiC grains represents between 5 and 40 wt % of the mixture of SiC grains.

8. The process as claimed in claim 1, in which the precursor of β-SiC grains is chosen from the group consisting of a silicon powder in combination with amorphous carbon or graphite carbon, a silicon alkoxide in combination with amorphous carbon or graphite carbon, and a silicon-based organometallic compound.

9. A process for obtaining a structure made from a porous ceramic material comprising at least 95% of silicon carbide, SiC, comprising:
mixing various fractions of SiC grains, in order to obtain a mixture as claimed in claim 1;
shaping the filtering structure after compounding the mixture in a liquid such as water;
drying by heating or under microwave action; and
firing the shaped porous structure in a nonoxidizing atmosphere at a temperature between around 1450° C. and around 2300° C.

10. A porous structure capable of being obtained by a process as claimed in claim 9.

11. The porous structure as claimed in claim 10, the central part of which comprises a honeycomb filtering element or a plurality of honeycomb filtering elements joined together by a joint cement, said element or elements comprising a set of adjacent ducts or channels with axes parallel to one another separated by porous walls, said ducts being stopped by plugs at one or the other of their ends to delimit inlet chambers opening onto a gas intake face and outlet chambers opening onto a gas discharge face, in such a way that the gas passes through the porous walls.

12. A catalytic filter or support obtained from a structure as claimed in claim 10 by deposition of at least one active catalytic phase comprising at least one precious metal selected from the group consisting of Pt, Rh and Pd and optionally an oxide selected from the group consisting of CeO₂, ZrO₂, and CeO₂/ZrO₂.

13. An exhaust line of a diesel or petrol engine comprising a catalytic support as claimed in claim 12.

14. A particulate filter in an exhaust line of a diesel or petrol engine comprising a catalytic filter as claimed in claim 12.

14. A particulate filter in an exhaust line of a diesel or petrol engine comprising a catalytic filter as claimed in claim 12.
